(19) United States
(12) Patent Application Publication
(10) Pub. No.: US 2025/0348331 A1
(43) Pub. Date: Nov. 13, 2025

(54) USER INTERFACE ELEMENT GENERATION FOR DIGITAL ASSISTANTS

(71) Applicant: SAP SE, Walldorf (DE)

(72) Inventors: Jan Scheuermann, Mannheim (DE); Anneke de Weerd, Karlsruhe (DE); Julian Seibel, Hauenstein (DE); Sebastian Schuetz, Mannheim (DE)

(21) Appl. No.: 18/658,139

(22) Filed: May 8, 2024

(51) Int. Cl. G06F 9/451

(52) U.S. Cl. CPC G06F 9/451

(57) ABSTRACT

Systems and methods described herein relate to the use of generative artificial intelligence to facilitate rendering of user interface elements in a user interface associated with a digital assistant. A backend response is automatically generated in response to user input provided via the user interface associated with the digital assistant. Prompt data is generated. The prompt data includes an instruction to generate an intermediate representation of an output data structure supported by the digital assistant. The prompt data is provided to a generative machine learning model to obtain the intermediate representation. The intermediate representation is processed to obtain the output data structure. One or more user interface elements are rendered based on the output data structure. The one or more user interface elements present the response data via the user interface associated with the digital assistant.

### TECHNICAL FIELD

The subject matter disclosed herein generally relates to digital assistants. More specifically, but not exclusively, the subject matter relates to systems and methods that utilize generative artificial intelligence (AI) to facilitate rendering of user interface elements in a user interface associated with a digital assistant.

### BACKGROUND

Various digital assistants, such as chatbots and other conversational agents, have been developed over the years. Some digital assistants obtain information by calling functions based on user input provided to the digital assistant. For example, if a user asks the digital assistant, “What is the weather like in London?”, the digital assistant communicates with a backend service to invoke a weather data function, resulting in a backend response that returns weather forecast data.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment that includes a digital assistant service system, according to some examples.

FIG. 2 is a block diagram of components of a digital assistant service system, according to some examples.

FIG. 3 diagrammatically illustrates interaction of a digital assistant service system with a plurality of platforms, an external server, and a plurality of backend services, according to some examples.

FIG. 4 is a block diagram of sub-components of a bot component of a digital assistant service system, according to some examples.

FIG. 5 is a flowchart illustrating a process of generating a user interface element from a backend response in a context of a digital assistant service system, according to some examples.

FIG. 6 is a flowchart illustrating operations of a method suitable for using a generative machine learning model to facilitate rendering of user interface elements in a user interface associated with digital assistant, according to some examples.

FIG. 7 diagrammatically illustrates training and use of a machine learning program, according to some examples.

FIG. 8 is a block diagram showing a software architecture for a computing device, according to some examples.

FIG. 9 is a block diagram of a machine in the form of a computer system, according to some examples, within which instructions may be executed for causing the machine to perform any one or more of the methodologies discussed herein.

### DETAILED DESCRIPTION

A “digital assistant,” as used herein, may include a software agent, application, or software-driven system that can interpret user input (e.g., user requests or user messages), execute or trigger associated actions, and provide relevant information or options back to the user, including through natural language conversations. Examples of digital assistants include chatbots, conversational agents, and voice assistants. A digital assistant may be provided by a digital assistant service via a web client at a user device. While non-limiting examples described herein focus on text inputs and text or text-including outputs provided in a user interface (e.g., on a display of the user device), it is noted that a digital assistant may interact with a user via various modalities, such as text, speech, touch, visual interface elements, or combinations thereof.

Information from a backend response can be presented by a digital assistant to the user in various formats, ranging, for example, from simple text to more complex data visualizations. Technical challenges may arise in presenting the information to the user in an appropriate or user-friendly format.

In some approaches, to handle such presentation, different backend response types (e.g., functions supported by digital assistant) can be mapped to respective output data structures, such as appropriate messages in JSON (JavaScript Object Notation) format containing natural language and defining user interface elements to be presented (e.g., tables, lists, buttons, charts, hyperlinks, text boxes, or combinations thereof). In some cases, backend responses are manually mapped to output data structures that are also manually crafted. In other words, a developer may need to create and maintain highly specific rules defining how data received from a particular backend service (e.g., via a particular Application Programming Interface (API)) should be presented to the user in a user interface.

This process can be cumbersome, time-consuming, or error-prone, and can result in a static or inflexible digital assistant configuration. For instance, save for the retrieved weather forecast data mentioned above, there is no variation in the wording of a digital assistant's answer to the “What is the weather like in London?” question across queries. Furthermore, creating these static mappings can be challenging, since it typically requires an understanding of how answers to certain questions should be formulated and formatted, and which options should be presented to the user, based on both user scenarios and digital assistant capabilities. Mappings may need to be manually changed to modify responses or features, and changes to mappings may require a bot component of the digital assistant to be recompiled and redeployed, which can be a slow process.

Generative AI can be leveraged to reduce the need for certain mappings, and to obtain more diverse, nuanced, or engaging outputs. A generative machine learning model, such as a large language model (LLM), can be prompted to fill a predefined user interface element template with response data obtained from a backend service. For example, an LLM can be leveraged to construct and populate a JSON format message using response data from a backend response. The message is then parsed and processed to render one or more user interface elements. This approach may be referred to as “direct template filling” since the generative machine learning model is directly generating the output data structure. Using an LLM for direct template filling can lead to a user experience that is less repetitive and predictable, and can reduce the burden on developers.

While the direct template filling approach can be useful, it may present technical challenges that limit the efficiency or scalability of a digital assistant service. For example, direct template filling, when performed by a generative machine learning model, can produce a relatively large number of output tokens, since the generative machine learning model is generating both the structure and content of the desired output data structure to be used downstream for user interface rendering (e.g., the generative machine learning model creates a full JSON format message for each output, including all response data to be shown to the user).

This approach can be expensive and time-consuming, resulting in higher costs and a risk of timeouts, particularly in systems with stringent performance requirements. For example, a digital assistant service system might trigger a timeout if the digital assistant takes longer than 15 seconds to produce an output. Direct template filling may also result in an unacceptable proportion of incorrect outputs.

Examples described herein utilize generative AI to facilitate more efficient rendering of user interface elements in a user interface associated with a digital assistant. Techniques described herein may enable a digital assistant service system to obtain benefits associated with a generative machine learning model, but with technical improvements that allow for greater token efficiency, faster response times, a reduced number of timeouts, or a reduced number of incorrect outputs.

An example method may be performed by a digital assistant service system. The method includes accessing a response provided to a digital assistant. The response may be a backend response from a backend service or another other system that is communicatively coupled to the digital assistant. In some examples, the backend response is generated automatically in response to user input provided via a user interface associated with the digital assistant. In some examples, the backend response is triggered via a generative machine learning model that interprets the user input and selects an appropriate function.

For example, the digital assistant can detect (e.g., through generative AI processing of a user message), based at least partially on the user input, a function identifier associated with a function from among a plurality of functions supported by the digital assistant, and, in response to detecting the function identifier, automatically invoke the function to obtain the backend response. Based on the backend response, the digital assistant may then cause generation of one or more suitable user interface elements to present information, options, or features within the backend response, as described herein.

The method may include generating prompt data that includes an instruction to generate an intermediate representation. The term “intermediate representation,” as used herein, refers to an intermediate or transitional representation or data format. The intermediate representation may encapsulate a structure or content, or both a structure and content, of output data to be presented to the user. The intermediate representation may be utilized between the “raw” backend response and final output intended for generating user interface elements. The intermediate representation may thus be regarded as an intermediate representation of an output data structure supported by the digital assistant, as described below.

In some examples, the intermediate representation is a simplified or abstracted version of data, such as a condensed metalanguage representation, generated using a generative machine learning model. In some examples, the intermediate representation retains necessary information but is structured in a way that reduces overall token output of the generative machine learning model when compared to direct template filling. For example, in the process of generating user interface elements from a JSON format backend response, an intermediate representation might involve a scripting syntax representation, using a syntax such as Handlebars (which is a non-limiting example of a templating engine) that is generated by the generative machine learning model, but resolved without using the generative machine learning model to obtain the final output data structure. In some examples, the intermediate representation contains fewer tokens than the output data structure, thereby enabling a reduction in generative machine learning model-linked costs or latency when compared to approaches that use the generative machine learning model to generate the output data structure directly. Accordingly, the intermediate representation may be used indirectly in the rendering of the response data within the user interface.

Scripting syntax representations and condensed metalanguage representations are example types of intermediate representations. When using a scripting language, the digital assistant can resolve its scripting code using predefined rules and the response data to obtain the output data structure. The scripting syntax representation can include placeholders or variables that are later replaced with actual data to be presented to the user. The scripting language can also support constructs such as iterative operations (e.g., loops) and conditional operations, thereby reducing the token size of the intermediate representation while allowing the digital assistant service system to obtain the correct output data structure (e.g., using a processor-implemented resolver) that can then be directly used to generate the user interface elements. A scripting syntax representation may thus provide an efficient template that does not contain the actual response data but is used by the digital assistant service system for generating, for example, a final output JSON message that contains the actual response data.

When using a condensed metalanguage representation, data associated with the backend response can be expressed in an abstracted, streamlined, compact, or shortened form. For example, based on a predetermined vocabulary, the generative machine learning model can replace certain elements with shorter, more efficient terms or symbols. Such a representation may reduce the size and complexity of the data to be generated by a generative machine learning model without losing information that is needed for the output data structure. For example, instead of using “title”: “User Profile”, as may be the case in direct template filling, a condensed metalanguage might abbreviate this to ti: UserProfile, omitting quotation marks and using shorter keys to represent the same information. This form is then expanded (e.g., using a processor-implemented compiler or interpreter) outside of a context of the generative machine learning model to obtain the output data structure before final use or display.

The term “output data structure,” as used herein, refers to organized data that is used to render one or more user interface elements. The output data structure is generated in a format supported by the digital assistant for user interface rendering. For example, in a digital assistant that processes natural language, the output data structure might be an object that represents a message defining one or more user interface elements (e.g., a button object, a list object, a card object, a text object, a hyperlink object, a chart object, or combinations thereof). An application executed at a user device, such as a web client, may be configured to render the user interface elements based on the output data structure. JSON is a lightweight and widely-used data interchange format, and is a non-limiting example of a format used in the output data structure to allow a user-facing application to parse and render the relevant user interface elements.

Accordingly, in some examples, the output data structure comprises a message in a predetermined format supported by the digital assistant, and the message is processed to generate the one or more user interface elements to present the response data via the user interface of the digital assistant. As mentioned, the prompt data may include an instruction to the generative machine learning model to generate the intermediate representation. The prompt data may instruct the generative machine learning model as to how to generate the intermediate representation, such as via an instruction to use a particular scripting language or via an instruction to use a particular vocabulary to generate a condensed metalanguage representation.

The method may include selecting, based on the backend response, one or more user interface element templates. For example, the backend response may be analyzed by the digital assistant service system to identify one or more user interface element templates (e.g., a list template and a button template) from a set of stored templates to be used in the output data structure. A selected user interface element template may be included in the prompt data. The prompt data may also include the response data, or at least a subset thereof. In some examples, the prompt data includes one or more samples of intermediate representations to facilitate generation of a new intermediate representation by the generative machine learning model.

The method may include providing, by the digital assistant service system, the prompt data to the generative machine learning model to obtain the intermediate representation, and then processing the intermediate representation to obtain the output data structure. For example, the digital assistant service system may execute a resolver to obtain the output data structure from a scripting syntax representation, or it may execute a compiler or interpreter to obtain the output data structure from a metalanguage representation.

In some examples, the intermediate representation is generated using generative AI, while the output data structure is generated from the intermediate representation without using generative AI, thereby enabling a reduction or potential reduction in the number of tokens to be generated via a generative AI system. Once the output data structure has been generated, the digital assistant service system may cause one or more user interface elements to be rendered via the user interface (e.g., the user interface of a web client). The user interface elements are generated according to the output data structure. Where one or more user interface element templates are identified in the prompt data provided to the generative machine learning model, the one or more user interface elements rendered via the user interface may each correspond to one of the one or more user interface element templates.

Examples described herein improve the functioning of a computing system by providing a more computationally efficient digital assistant service system. Performance of a digital assistant service system that leverages generative AI can be improved by utilizing prompts that instruct a generative machine learning model to produce an intermediate representation instead of directly generating output data structures. The intermediate representation can be resolved outside of a context of the generative machine learning model.

Where a scripting language is utilized, the digital assistant service system may, at least in some cases, provide the technical benefit of producing the same intermediate representation (and thus the same number of tokens) regardless of the number of entries in a backend response, such as where the backend response contains multiple results responsive to a search query. A scripting syntax, such as Handlebars, thus allows for dynamic insertion of data into a template without the generative machine learning model needing to regenerate an entire structure for each new set of data. In some examples, one scripting template can be created during design time and reused for different backend responses of the same type (e.g., associated with the same function or API), reducing the number of generative machine learning model calls and making the system more scalable.

Where a metalanguage is utilized, the digital assistant service system can also provide the technical benefit of reducing the number of tokens to be generated by the generative machine learning model without losing valuable information in the process. By using more compact representations of actual response data, or a scripting language that does not include the actual response data, a more token-efficient system can be obtained, while still allowing for these intermediate forms to be accurately compiled or resolved into the final format that defines elements displayed to the user. Further, by reducing the time it takes to generate generative machine learning model outputs, approaches described herein may scale better at runtime from a performance perspective. This can result in an improved user experience (e.g., due to fewer timeouts).

In some examples, human errors in a digital assistant service system's outputs can be reduced by obviating the need for certain manual or static mappings between functions and output data structures. The burden on developers can be reduced by obviating the need to create or maintain certain templates, predetermined output data structures, or data mappings.

Approaches described herein may also improve the variation in the outputs of a digital assistant, since a generative machine learning model is utilized to produce templates or intermediate outputs. Moreover, the structured approach of resolving or compiling final output data structures outside of a generative AI environment may reduce the number of incorrect outputs produced by the digital assistant.

When the effects in this disclosure are considered in aggregate, one or more of the methodologies described herein may obviate a need for certain efforts or resources that otherwise would be involved in developing, deploying, or scaling digital assistants. Computing resources utilized by systems, devices, databases, or networks may be more efficiently utilized or reduced, e.g., as a result of a reduction in the computational load placed on a generative machine learning model (e.g., an LLM). Examples of such computing resources may include processor cycles, network traffic, memory usage, data storage capacity, power consumption, and cooling capacity.

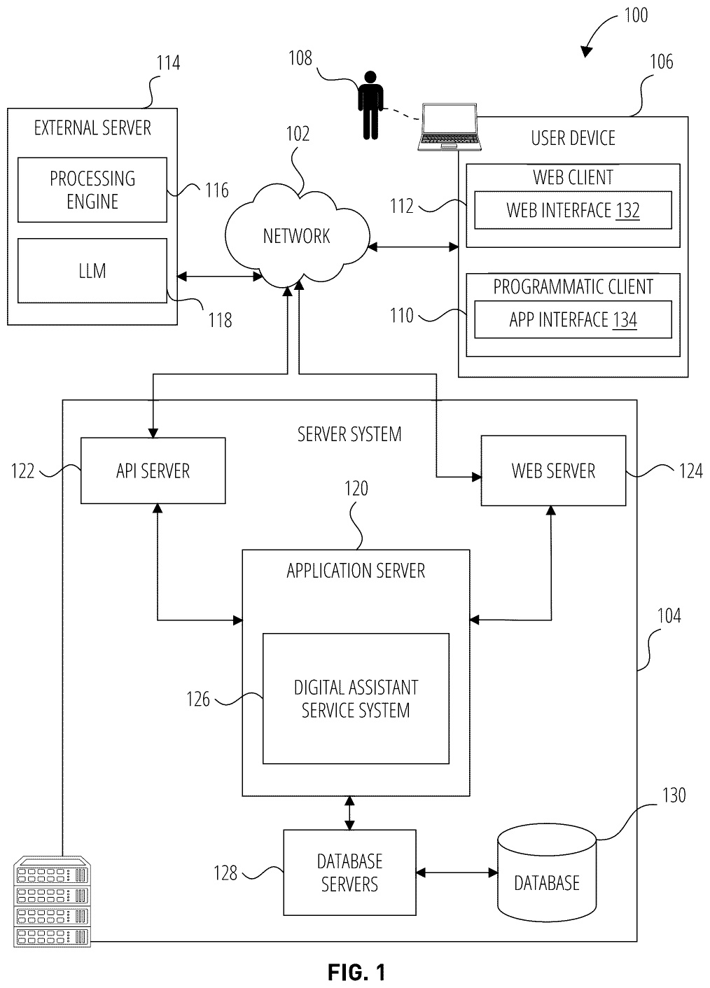

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 106 that is accessed by a user 108. A web client 112 (e.g., a browser) or a programmatic client 110 (e.g., an “app”) may be hosted and executed on the user device 106.

An API server 122 and a web server 124 provide respective programmatic and web interfaces to components of the server system 104. A specific application server 120 hosts a digital assistant service system 126, which includes components, modules, or applications. It will be appreciated that the digital assistant service system 126 may be hosted across multiple application servers in other examples.

The user device 106 can communicate with the application server 120. For example, the user device 106 can communicate with the application server 120 via the web interface supported by the web server 124 or via the programmatic interface provided by the API server 122. It will be appreciated that, although only a single user device 106 is shown in FIG. 1, a plurality of user devices may be communicatively coupled to the server system 104 in some examples. For example, multiple users access the digital assistant service system 126 using respective user devices to utilize its functionality. Further, while certain functions may be described herein as being performed at either the user device 106 (e.g., web client 112 or programmatic client 110) or the server system 104, the location of certain functionality either within the user device 106 or the server system 104 may be a design choice.

The application server 120 is communicatively coupled to database servers 128, facilitating access to one or more information storage repositories, such as database 130. In some examples, the database 130 includes storage devices that store information to be processed by the digital assistant service system 126 or other components shown in FIG. 1. For example, the database 130 may store function data associated with functions supported by a digital assistant. The function data may be updated periodically such that the digital assistant supports a dynamic set of functions. The database 130 may further store user interface element templates defining the structure or format of elements presented to the user 108 at the user device 106. The database 130 may also store prompt data that is used to prompt one or more generative machine learning models to perform certain tasks or generate certain data.

The application server 120 accesses application data (e.g., application data stored by the database servers 128) to provide one or more applications or software tools to the user device 106 via a web interface 132 or an app interface 134. In particular, the user 108 is enabled to access a digital assistant provided by the digital assistant service system 126 via the user device 106.

The digital assistant service system 126 functions to handle user interactions and fulfillment of capabilities for the digital assistant. The digital assistant service system 126 includes various components to interpret user input, determine and invoke appropriate functions, generate responses, present responses using appropriate or user-friendly interface elements, and integrate with external systems.

In some examples, the digital assistant service system 126 enables natural language conversations by receiving user input, analyzing input to determine appropriate responses, calling or triggering the calling of functions to execute capabilities, and generating conversational responses. Further, the digital assistant service system 126 enables presentation of outputs via suitable user interface elements, that can range from simple text objects to more complex objects such as lists, tables, or visualizations, or to interactive objects such as buttons or other selectable elements. The digital assistant service system 126 maintains context to enable conversations/dialogs spanning multiple exchanges. The digital assistant service system 126 may provide a modular architecture that integrates external systems and functions (e.g., via standardized interfaces).

The digital assistant service system 126 can integrate or communicate with a variety of platforms and endpoints. For example, the user 108 can access the digital assistant provided by the digital assistant service system 126 via the web client 112 or the programmatic client 110, and interact with the digital assistant via the web interface 132 or the app interface 134.

In some examples, the user 108 uses the web interface 132 of the web client 112 of the user device 106 to access the environment provided by the digital assistant service system 126. For example, the web client 112 may transmit instructions to and receive responses from the server system 104 to allow it to update a user interface, creating a dynamic and interactive web application experience. In some examples, the digital assistant is provided as a support tool that is presented as a window in association with a primary application. The digital assistant service system 126 may add an AI-powered, conversational experience “on top of” a standard user interface provided by the web client 112 and web interface 132 at the user device 106. The user interface may be dynamically updated with user interface elements based on output data structures received from the server system 104. For example, the server system 104 may submit JSON format messages to the user device 106 that defines user interface elements to be rendered and presented via the web interface 132 or app interface 134.

In some examples, at least parts of the digital assistant may run on the web client 112, and its user interface can be updated without necessarily transmitting instructions to or receiving responses from the server system 104. It will be appreciated that while the digital assistant service system 126 is shown as residing within the server system 104 in FIG. 1, functionality or features of the digital assistant service system 126 may be provided so as to run at least partially at the user device 106.

In some examples, the digital assistant service system 126 provides AI-assisted or AI-driven digital assistant services that include natural language interactions and interpretation. The digital assistant service system 126 may receive user queries, generate, and provide prompts to a machine learning model to obtain responses to user queries, assist with identifying scenarios and triggering functions, and present responses to the user 108. Accordingly, the digital assistant service system 126 may allow the user 108 to ask natural language questions or submit natural language requests, related, for example, to an application that the user 108 is working with or to a business function that the user 108 would like to perform. In some examples, a generative machine learning model (e.g., an LLM) is leveraged to identify scenarios, facilitate the triggering of functions, or prepare user outputs.

The digital assistant service system 126 may also use a machine learning model to facilitate the generation of user interface elements. For example, and as described in greater detail elsewhere, after a function has been triggered and a response has been received by the digital assistant service system 126 from a backend service, the machine learning model can be used to generate an intermediate representation that is then resolved, compiled, or interpreted by the digital assistant service system 126 to generate a suitable output data structure for presenting response information to the user 108 via the web interface 132 or the app interface 134. A generative machine learning model may be used to generate such intermediate representations.

A generative machine learning model leveraged by the digital assistant service system 126 may be hosted on an external server 114 that provides a processing engine 116 and a trained model, such as an LLM 118, as shown in FIG. 1. However, in other examples, the machine learning model can be internally hosted. While a single LLM 118 is shown in FIG. 1, it will be appreciated that multiple generative machine learning models may be used (e.g., a first model may be used to trigger function calls and a section model may be used to generate intermediate representations).

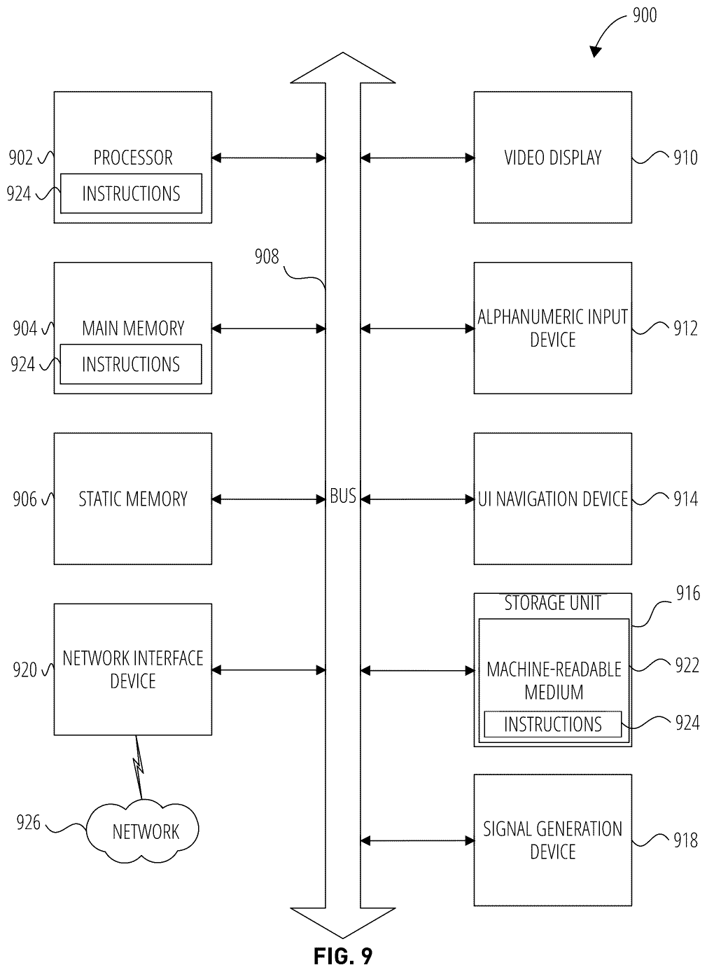

In some examples, the application server 120 is part of a cloud-based platform provided by a software provider that allows the user 108 to utilize the features of the digital assistant service system 126. One or more of the application server 120, the database servers 128, the API server 122, the web server 124, and the digital assistant service system 126, or parts thereof, may each be implemented in a computer system, in whole or in part, as described below with respect to FIG. 9.

In some examples, external applications (which may be third-party applications), such as applications executing on the external server 114, can communicate with the application server 120 via the programmatic interface provided by the API server 122. For example, a third-party application may support one or more features or functions on a website or platform hosted by a third party, or may perform certain methodologies and provide input or output information to the application server 120 for further processing or publication.

Referring more specifically now to the external server 114, the external server 114 houses the LLM 118 and related processing capabilities. The external server 114 may provide an external, scalable server environment dedicated to running and serving queries to the LLM 118.

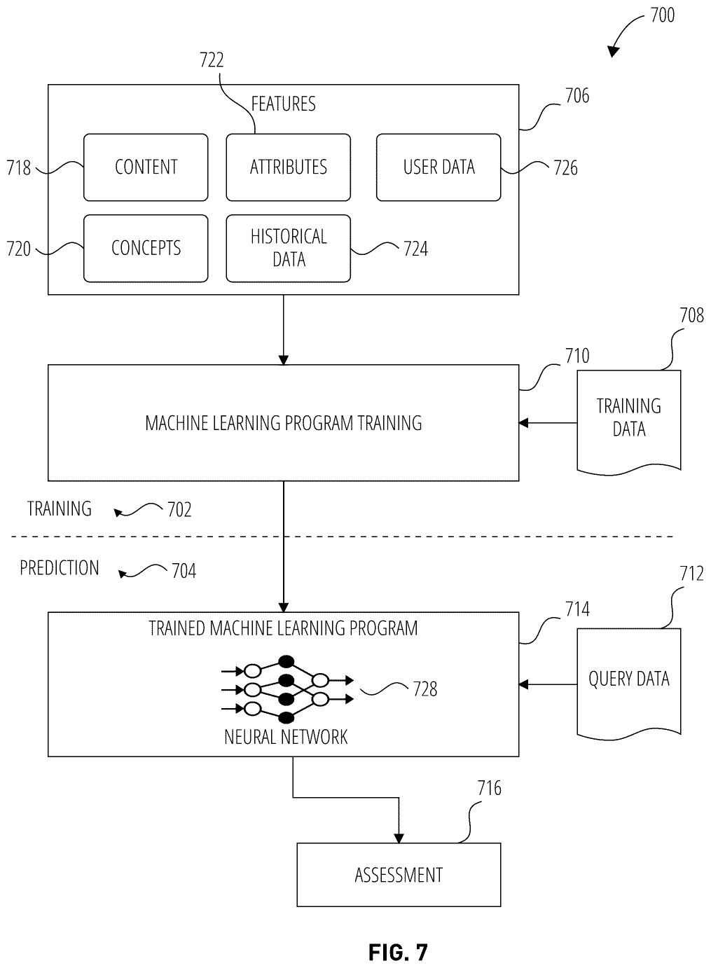

The LLM 118 is a computational model developed for the tasks of processing, generating, and understanding language. It employs machine learning methodologies, including deep learning architectures. The training of the LLM 118 may utilize comprehensive data sets, such as vast data sets of textual content, to enable the LLM 118 to recognize patterns in language. The LLM 118 may be built upon a neural network framework, such as the transformer architecture. The LLM 118 may contain a significant number of parameters (e.g., in excess of a billion), which are adjusted during training to optimize performance. Machine learning techniques are described in greater detail with reference to FIG. 7.

The processing engine 116 may be a component running on the external server 114 that is communicatively coupled to the LLM 118. The processing engine 116 may handle certain preprocessing of data before sending it to the LLM 118 and certain postprocessing of the responses received from the LLM 118. For preprocessing, the processing engine 116 may tokenize, compress, or format the data to optimize it for the LLM 118. For postprocessing, it may format the LLM 118 response, perform detokenization or decompression, and prepare the response for sending back to the requesting system (e.g., the digital assistant service system 126).

The LLM 118 may provide language processing capabilities that can assist with user queries, understanding context or instructions, identifying functions of interest, identifying further information required to perform functions, understanding dependencies between functions or actions, invoking function calls, generating natural language responses, or generating intermediate representations. Referring to the latter function, based on its training data, the LLM 118 may provide suitable capabilities for generating scripting language or metalanguage as part of an intermediate representation.

In some examples, an LLM has been fine-tuned on relevant tasks, conversations, or other data to enhance its ability to provide useful insights, representations, responses, or solutions. For example, an LLM may be fine-tuned to focus on generating intermediate representations, such as condensed metalanguage representations or scripting syntax representations, that can be processed by the digital assistant service system 126 to obtain suitable output data structures.

The digital assistant service system 126 may integrate with the LLM 118 to add a human-like, conversational interface for users interacting with a digital assistant. Alternatively or additionally, the digital assistant service system 126 may use the LLM 118 internally to generate intermediate representations that are not directly exposed to end users.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

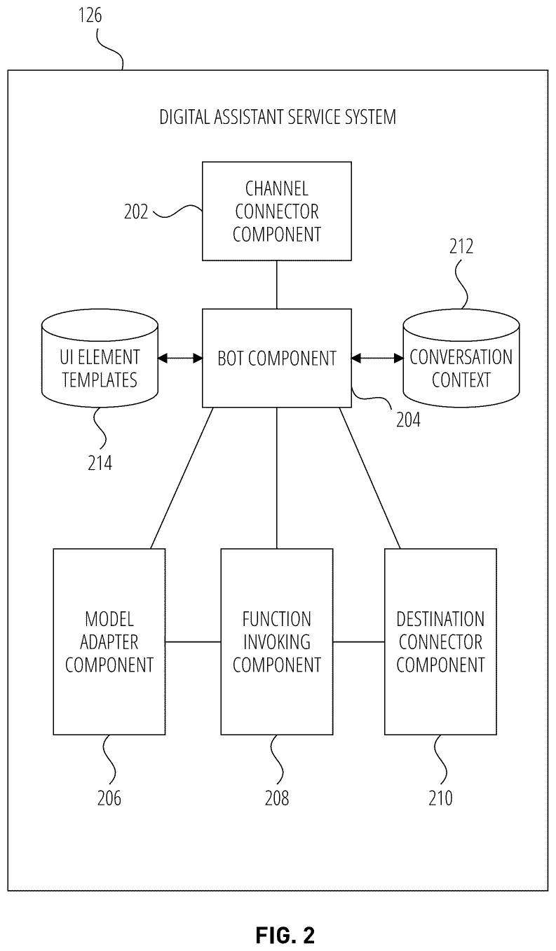

FIG. 2 is a block diagram illustrating components of the digital assistant service system 126 of FIG. 1, according to some examples. The digital assistant service system 126 is shown to include a channel connector component 202, a bot component 204, a model adapter component 206, a function invoking component 208, a destination connector component 210, a conversation context 212, and user interface element template storage 214.

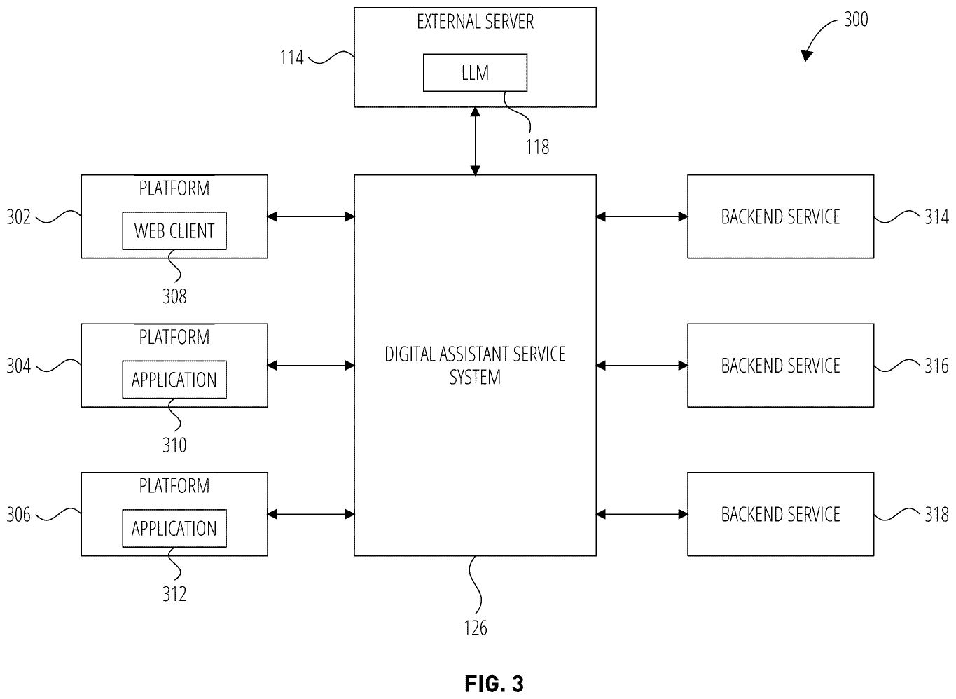

The channel connector component 202 serves as an interface to external user systems and devices accessing the digital assistant, such as the user device 106 of FIG. 1. The channel connector component 202 is configured to handle or translate various protocols and data formats to normalize communications between user devices and the digital assistant service system 126. This enables support for devices accessing the digital assistant via different channels (as is further described with reference to FIG. 3). The digital assistant may be configured to support multiple message types in addition to plain text (e.g., messages including images) or handle voice inputs. The digital assistant may be configured to support various types of output data structures, such as structures representing text, lists, tables, buttons, charts, or combinations thereof, enabling the digital assistant to present complex responses to the user 108.

The channel connector component 202 provides front-end integration functionality allowing, for example, the user 108 to open an application in the web client 112 and interact with the digital assistant via a chat window. In some examples, the channel connector component 202 receives output data structures from the bot component 204 and facilitates the rendering of user interface elements based on those output data structures.

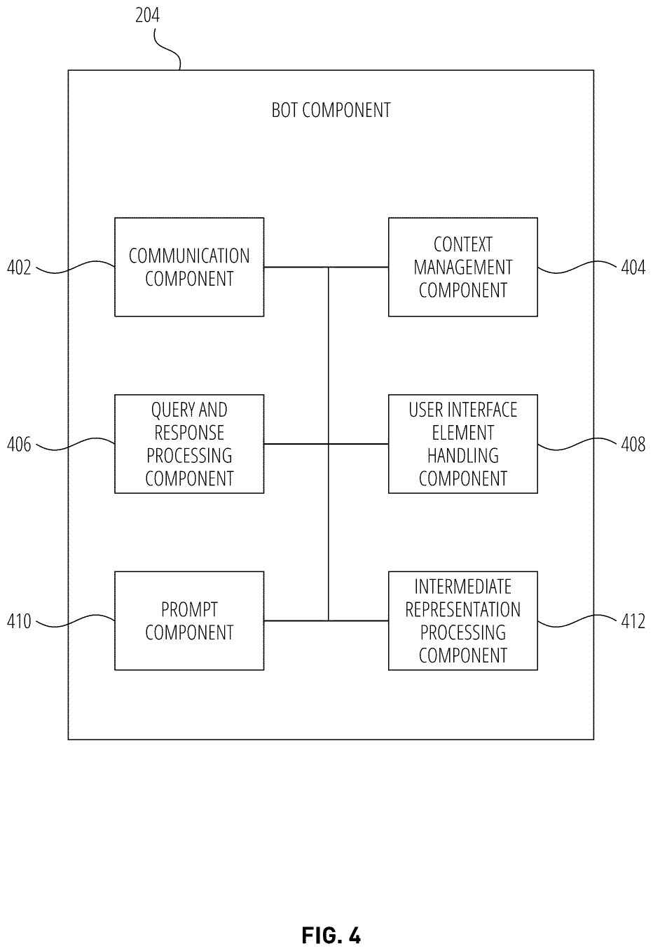

The bot component 204 is responsible for various functions, and a description of example sub-components of the bot component 204 is provided with reference to FIG. 4. Referring again to FIG. 2, the bot component 204 receives user input provided to the digital assistant from the channel connector component 202. In cases where the digital assistant service system 126 provides access to multiple different digital assistants, the bot component 204 may direct user input to the correct digital assistant.

The bot component 204 also manages the conversation context 212. In some examples, upon receiving a new user message, the bot component 204 transmits the new user message together with the latest set of other data (e.g., conversation history or function data), to be included in a prompt for scenario selection, to the model adapter component 206.

In some examples, the bot component 204 is responsible for using a generative machine learning model to facilitate rendering of user interface elements. Upon receiving a response from a backend service via the destination connector component 210 or the function invoking component 208, the bot component 204 can transmit the response to the model adapter component 206 for inclusion in a prompt for intermediate representation generation. The intermediate representation is then used to render an output data structure.

The user interface element template storage 214 stores a plurality of user interface element templates or types. Each template in the user interface element template storage 214 may define a structure, content, format, attributes, or combination thereof, for a particular user interface element that is supported by the digital assistant. For example, the user interface element template storage 214 may include data defining aspects of a list, a table, buttons, and other elements to enable such elements to be properly rendered. The user interface element template storage 214 may be contained in the database 130, in some examples.

In this context, a “user interface element” is a component or item that can be rendered within a user interface associated with the digital assistant (e.g., presented on a display of the user 108 in a context of the web client 112). These elements can be used to present response data from backend response as well as direct responses generated by the bot component 204 or a generative machine learning model to the user. For example, where a backend response provides weather data with multiple data points, one or more user interface elements, such as a table or a list, can be used to present the response data in a user-friendly format.

A user interface element can be a simple object or item, such as a piece of text, or a more complex object or item, such as a table, list, or chart. A user interface element can also be or include an interactive element that allows the user to interact with the digital assistant service system 126 by selecting or manipulating the element, such as a button, an input field, a slider, checkbox, or the like.

The model adapter component 206 serves as an adapter layer between a bot runtime and one or more generative machine learning models. For exemplary purposes, the LLM 118 of FIG. 1 is referenced below. The model adapter component 206 is responsible for generating or finalizing prompt data to provide to the LLM 118, and for receiving outputs generated by the LLM 118. For example, the model adapter component 206 takes data received from the bot component 204, and adds additional data or transforms some of the data to generate the prompt data.

The LLM 118 can be prompted to handle functions or general conversations with the user, and can also be prompted to generate intermediate representations. When prompting the LLM 118 to handle functions, the model adapter component 206 may add function data that identifies a set of functions available to the digital assistant and describes their characteristics (e.g., what they do) and parameters (e.g., the arguments needed to call the function). When prompting the LLM 118 to generate an intermediate representation, the prompt provided by the model adapter component 206 may include an instruction as to how to generate the intermediate representation as well as context data (e.g., a response from a backend service and message history).

The model adapter component 206 may also add other data to the prompt data, such as a role definition indicating to the LLM 118 what its role is. Various types of additional contextual information can be provided to the generative machine learning model to guide it with respect to its task or certain output requirements, such as a desired level of detail, format, and style.

In some examples, the LLM 118 is responsible for natural language processing, conversation generation, function resolution, and slot filling (where needed to complete a function call, for example). The model adapter component 206 may parse a response received from the generative machine learning model to determine a response type. For example, the model adapter component 206 may determine whether the response is a function call or a direct response. If the response is a direct response, the model adapter component 206 may return the response directly to the bot component 204 to cause the response to be presented at a user device (e.g., as part of a general conversation between the user and the digital assistant). If the response is a function call, the function call is transmitted to the function invoking component 208. The model adapter component 206 may detect that the response is a function call based on a structure or schema of the response, or some other function identifier.

In other cases, a response from the LLM 118 can include an intermediate representation. Where the LLM 118 is used for intermediate representation generation, the model adapter component 206 receives the intermediate representation from the LLM 118 and passes the intermediate representation to the bot component 204. This allows the bot component 204 to process the intermediate representation together with the relevant information (e.g., a response from a backend service) to ultimately obtain an output data structure that is usable for rendering user interface elements via the channel connector component 202 and the user device 106.

The model adapter component 206 may handle integration with API endpoints, such as one or more API endpoints of the LLM 118 (e.g., by communicating with the processing engine 116 of the external server 114). Prompt data may be transmitted to the LLM 118 as a single prompt. Alternatively, different portions of the prompt data may be provided separately. For example, certain data, such as a role definition or a task outline, may be provided as a “pre-prompt” portion of the prompt data, given that such data would be included in the context window of the LLM 118 for each or multiple calls. Other data, such as a particular backend response or conversation history data, may then be provided separately. Prompt data may be updated periodically or after certain events, and updated prompt data can be passed to the LLM 118 via the model adapter component 206.

In some examples, the bot component 204 or the model adapter component 206 is responsible for preprocessing user input. For example, the model adapter component 206 may adjust the format of a user query or modify certain data items in the user query. In some cases, the model adapter component 206 may detect that the user query includes personally identifiable information (PII) and perform de-identification on the relevant data items before sending the prompt data to the LLM 118 (the model adapter component 206 may then re-identify the response from the generative machine learning model to the extent needed after receiving the response). In some cases, the model adapter component 206 may automatically transform a message, or parts thereof, to reduce its overall size (e.g., perform token minimization to reduce token size).

The function invoking component 208 operates to initiate or complete actions associated with functions supported by the digital assistant. The function invoking component 208 receives function calls (e.g., an identifier of the function and its arguments) and then determines which function to invoke. For example, the LLM 118 selects a particular scenario based on the user input received, and then obtains, from the user (or from the conversation context 212 or some other data source), parameter values for a function corresponding to the selected scenario. The function invoking component 208 then handles the invocation of that function once all parameter values are available and (where applicable) confirmed by the user.

The function invoking component 208 may transmit instructions to the destination connector component 210 to retrieve information from one or more destinations or to call one or more endpoints to perform actions. The function invoking component 208 may also receive outputs from one or more destinations, referred to herein as “backend responses.” A backend response may be a response received by the digital assistant service system 126, or a component thereof, that provides information or output relating to a function, but that is not directly passed on to the user 108. For example, the backend response can be a simple JSON object with values that are to be processed into a format that can be presented to the user 108.

A backend response received by the function invoking component 208 via, for example, an API response, can have a predefined pattern or format. For example, the LLM 118 may provide a function call for a “Get Current Weather” function (get_current_weather) which results in retrieval of a temperature and weather description for a particular city (included in the function arguments) in a predetermined format (e.g., a JSON object). The function invoking component 208 may then pass the backend response to the bot component 204 for processing such that the backend response can be presented in an appropriate manner to the user 108.

As described elsewhere, the bot component 204 or the model adapter component 206 can work with the LLM 118 to obtain an intermediate representation, and then process the intermediate representation using the backend response to obtain a final output data structure. Outputs presented to the user are stored in the conversation context 212 to ensure that the generative machine learning model has access to an up-to-date conversation history for subsequent queries.

The destination connector component 210 connects the digital assistant service system 126 to one or more backend services, such as functional modules of a business or data sources. For example, the destination connector component 210 may connect the digital assistant service system 126 to multiple business modules, such as an enterprise resource planning system, a human resources system, an account system, or a customer relationship management system. The destination connector component 210 may provide integration points to enable function calling directed at a selected destination. The function invoking component 208 or the destination connector component 210 may be responsible for selecting, for example, the correct API endpoint to call for a particular function selected by the user 108.

The diagram 300 of FIG. 3 diagrammatically illustrates interaction of the digital assistant service system 126 of FIG. 1 with a plurality of platforms 302, 304, 306, with the external server 114 of FIG. 1, and with a plurality of backend services 314, 316, 318, according to some examples. The platforms 302-306 shown in FIG. 3 represent different client environments from which users may interact with a digital assistant. For example, users may access the digital assistant provided by the digital assistant service system 126 using a web client 308 associated with the platform 302, using an application 310 associated with the platform 304, or using an application 312 associated with the platform 306.

The channel connector component 202 of FIG. 2 is configured to enable the digital assistant service system 126 to integrate with the different platforms 302-306. For example, the platform 302 may be a human resources management tool that has the digital assistant integrated into its web client 308, while the platform 304 is a data analytics platform that has the digital assistant integrated into its application 310, and the platform 306 is a cloud analytics ecosystem that provides a conversational AI experience through the application 312. In each case, a user can send queries or messages to the digital assistant service system 126 and receive responses. The responses may include user interface elements as described herein.

The digital assistant service system 126 receives user input from users accessing the platforms 302-306 and transmits responses to their respective user devices via the platforms 302-306. The digital assistant service system 126 also, in some examples, communicates with the LLM 118 hosted by the external server 114 to obtain AI-generated responses, intermediate representations, or other data. In other examples, the digital assistant service system 126 may have an internal generative machine learning model that it uses to generate responses, intermediate representations, or other data structures.

As mentioned, in some cases, a response generated by the LLM 118 is a direct response that is directly passed on to a user device of a user. A direct response refers, for example, to conversational content generated by the digital assistant and provided directly back to the user device of the user (e.g., the user device 106 of the user 108), without invoking execution of a function. Direct responses may include clarification questions (e.g., “I need more information from you to generate your purchase order . . . ”), notifications (e.g., “Your purchase order will be created.”), “small talk” responses (e.g., “I am well, thank you for asking. How can I help you?”), or other dialog generated based on the conversational context. Unlike function calls, direct responses do not trigger operations or retrieval of new information from external services (e.g., one of the backend services 314-318, as described below).

In other cases, the response represents a function call. The digital assistant may cause invocation of a specified function when the LLM 118 passes, for example, a function name and arguments to the model adapter component 206. This results in execution of the encapsulated capability, such as retrieval of data or performance of operations associated with the function. A function call may thus invoke external logic and access external information rather than responding based on existing conversational context.

The digital assistant service system 126 detects that the response represents a function call. For example, the model adapter component 206 of the digital assistant service system 126 detects that the response is provided in JSON format and includes a function name and arguments relating to a current scenario being handled by the external server LLM 118 (e.g., as opposed to a free-text response or simple string of data that represents a direct response). In response, the digital assistant service system 126 causes invocation of the relevant function (e.g., dialog function) by communicating with a selected one of the backend services 314-318.

The backend services 314-318 may provide capabilities and data sources leveraged by the digital assistant. For example, the backend service 314 may be associated with an enterprise resource planning system, while the backend service 316 is associated with a customer relationship management system, and the backend service 318 is associated with a billing system. Loose coupling (e.g., via APIs) may allow backend services to evolve independently, or to be dynamically changed, while still being available to be leveraged by the digital assistant service system 126.

The digital assistant service system 126 (e.g., the function invoking component 208) may access a mapping of functions to backend services (e.g., respective API endpoints) that allow the digital assistant service system 126 to request the relevant information or action from one of the backend services 314-318 in response to receiving a function call from the LLM 118.

Once a backend response is received from one of the backend services 314-318, the digital assistant service system 126 can process the backend response to obtain an output data structure that is suitable for rendering user interface elements (e.g., a JSON message that defines the buttons or other elements to be presented, as well as any text). In other words, the digital assistant service system 126 can transform a “raw” response into a user-facing output.

Referring back to FIG. 2, as mentioned, the function invoking component 208 can receive (e.g., via the destination connector component 210) a backend response. A simple backend response might, for example, read as follows in the case of a request for weather forecast data:

```
{
  “location”: “New York”,
  “date”: “12/12/2024”,
  “forecast”: {
    “condition”: “Sunny”,
    “temperature”: “75° F”,
    “humidity”: “50%”
  }
}
```

It may be undesirable to pass the backend response directly to the user, for example, since it is preferable to process the backend response into a format from which it can be presented via one or more user-friendly interface elements. It may also be desirable to add interactive elements, such as buttons, sliders, menus, or other elements, thus necessitating converting the backend responses to a suitable output data structure. The bot component 204 may select, based on the backend response, one or more user interface element templates from the user interface element template storage 214.

Instead of relying on a static mapping to generate the output to be shown at the user device 106, the digital assistant service system 126 can leverage the LLM 118. In some examples, the LLM 118 can be prompted to perform direct template filling, thereby creating an output data structure based on the one or more selected user interface element templates and the backend response. In other examples, to reduce the number of tokens to be generated by the LLM 118, the LLM 118 can instead be prompted to generate an intermediate representation which is then processed by the bot component 204 without using generative AI to obtain the desired output data.

FIG. 4 is a block diagram illustrating sub-components of the bot component 204 of FIG. 2, according to some examples. The bot component 204 is shown to include a communication component 402, a context management component 404, a query and response processing component 406, a user interface element handling component 408, a prompt component 410, and an intermediate representation processing component 412.

The communication component 402 handles the exchange of messages between the user and the digital assistant, managing both incoming and outgoing communication (e.g., via the channel connector component 202 of FIG. 2). The communication component 402 may also handle the receipt of backend responses and the routing of the backend responses to other sub-components of the bot component 204.

The context management component 404 is configured to manage the conversation context 212 as shown in FIG. 2. The context management component 404 can maintain the state of the digital conversation, keeping track of user interactions and the digital assistant's context to provide coherent and relevant responses.

In some examples, the conversation context 212 stores not only the history of a current session between the user 108 and the digital assistant, but also the conversation history data of one or more previous sessions between the user 108 and the digital assistant, thereby enhancing the ability of the digital assistant to, for example, resolve co-references. In other words, when a prompt is generated for processing by the generative machine learning model (e.g., the LLM 118), it may include details of earlier conversations between the user and the digital assistant. The conversation history data may be stored as context, for example, in a context window of the generative machine learning model.

The query and response processing component 406 may process both user inputs and backend responses. For example, the query and response processing component 406 can work with the LLM 118 to process a user query to determine a function that is of interest to the user 108. When a backend response is received (e.g., after the function has been invoked) by the bot component 204, the query and response processing component 406 can process the backend response to facilitate generation of the appropriate output data structure.

The user interface element handling component 408 may operate to create new user interface element templates and modify or maintain existing templates. In some examples, after receiving a backend response, the query and response processing component 406 works with the user interface element handling component 408 to retrieve one or more relevant user interface element templates from the user interface element template storage 214. The user interface element handling component 408 then provides the relevant template or templates to the query and response processing component 406 or the prompt component 410 for further handling.

Various techniques may be used to identify, infer, or select a user interface element template. For example, the user interface element handling component 408 may follow a rules-based approach in which a user interface element template matching the format of the backend response is selected (e.g., if the backend response includes an array, the user interface element handling component 408 automatically selects a list template or automatically avoids a plain or simple text output). Alternatively or additionally, the user interface element handling component 408 may utilize AI to analyze the backend response and the supported user interface element templates to determine the most suitable template or templates (e.g., a dedicated machine learning model may be trained, using supervised learning, to identify one or more user interface element templates best suited to the contents of a given backend response).

In some cases, the relevant user interface element template corresponding to a particular function may be explicitly defined (e.g., by a capability developer). For example, a developer might explicitly record that certain response data should be presented to the user 108 in a list format. In such a case, the bot component 204 may access stored data (e.g., from the database 130) indicating this correspondence and select the relevant user interface element.

In some examples, the bot component 204 leverages generative AI to transform a “raw” response from a backend service to a suitable output data structure (e.g., to a JSON format message that defines how the user should be presented with the response data). The prompt component 410 may work with the model adapter component 206 of FIG. 2 to generate prompt data that instructs a generative machine learning model (e.g., the LLM 118) to generate an intermediate representation of an output data structure supported by the digital assistant.

For example, the prompt component 410 generates a prompt that instructs the LLM 118 to generate a scripting syntax representation associated with the backend response and one or more selected user interface element templates included in its context data. As another example, the prompt component 410 generates a prompt that instructs the LLM 118 to generate a condensed metalanguage representation of the backend response based on the one or more selected user interface user interface element templates.

The intermediate representation processing component 412 operates to process the intermediate representation generated by the generative machine learning model in order to obtain the final output data structure to transmit from the bot component 204. For example, the intermediate representation processing component 412 can execute a resolver module or a compiler module to transform or compile to the output data structure. In other words, the intermediate representation processing component 412 can take the output from the generative machine learning model, which is in an intermediate format, and processes it into a structured message ready for rendering user interface elements.

The intermediate representation processing component 412 may be configured to understand the semantics, structure, language, or vocabulary of the intermediate representation, and to use this understanding to construct a fully realized message. For example, the intermediate representation processing component 412 can ensure that the placeholders or condensed language in the intermediate representation are expanded and filled with the appropriate data, resulting in a complete and coherent message that accurately conveys the intended information.

The final output (e.g., the output data structure) may then automatically be passed on to the user interface element handling component 408 or the query and response processing component 406, which works with other components (e.g., the channel connector component 202 or the web client 112) to render the user interface elements that the user will see or interact with.

In some examples, at least some of the components shown in FIG. 1, FIG. 2, or FIG. 4 are configured to communicate with each other to implement aspects described herein. One or more of the components described herein may be implemented using hardware (e.g., one or more processors of one or more machines) or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

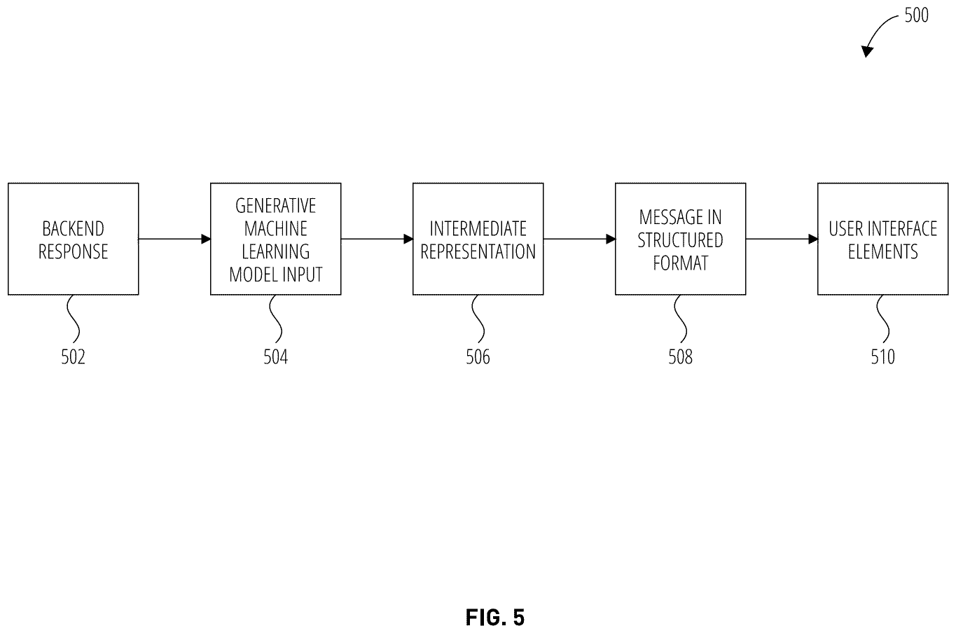

FIG. 5 is a flowchart illustrating a process 500 of generating user interface elements from a backend response in a context of the digital assistant service system 126 of FIG. 1, according to some examples. The process 500 starts with receipt, by the digital assistant service system 126, of a backend response 502.

The backend response 502 may be received in response to the invocation of a function supported by the digital assistant service system 126. In some examples, the backend response 502 is received via a backend service (e.g., the backend service 314 of FIG. 3). The backend response 502 may consist of data in a structured format, such as JSON. The backend response 502 contains response data that is needed by the digital assistant service system 126 to generate a response to the user's query, message, or action. An example JSON structure that serves as input data to be converted to an intermediate representation in the manner described herein is included below.

```
{
  “people”: [
    {
      “name”: {
        “firstname”: “Jan”,
        “lastname”: “Smith”
      },
      “username”: “jan_smith”,
      “birthdate”: “1985-01-15”,
      “salary”: 75000,
      “id”: 12345
    },
    {
      “name”: {
        “firstname”: “Jan”,
        “lastname”: “Doe”
      },
      “username”: “jan_doe”,
      “birthdate”: “1990-01-10”,
      “salary”: 65000,
      “id”: 12346
    } ,
    {
      “name”: {
        “firstname”: “Jan”,
        “lastname”: “Brown”
      },
      “username”: “jan_brown”,
      “birthdate”: “1982-01-20”,
      “salary”: 82000,
      “id”: 12347
    }
  ]
}
```

The digital assistant service system 126 then prepares generative machine learning model input 504. For example, the bot component 204 of FIG. 4 generates prompt data that instructs the generative machine learning model (e.g., the LLM 118) to generate an intermediate representation 506, as shown in FIG. 5. The preparation of the generative machine learning model input 504 may involve generating or compiling contextual information (e.g., including the backend response 502), one or more user interface element templates, user history, or other relevant data that the generative machine learning model may need to generate an accurate and contextually appropriate output that can be used downstream by the digital assistant service system 126.

Example prompt data for scripting generation is included below merely to illustrate certain aspects of the disclosure. It will be appreciated that certain context data (e.g., a backend response) is not shown below.

{
“role”: “system”,
“content”;
“You are a system to generate scripting code. These responses
follow a defined format and you only use the context data to
generate the response.
Instructions:
- Respond with a scripting code with handlebars.
- You have the following example for scripting if you receive
just one result entry use this card format: {\”type\”:
\“card\”, \“content\”: {\“title\”:
\“{{response[0].firstName}\”, \“subtitle\”:
\“{{response[0].username}\”, \“imageUrl\”: \“<image url>\”,
\“buttons\”: [{\“type\”: \“link\”, \“title\”: \“<button
title>\”, \“value\”: \“{{response[0].uri}\”}, {\“type\”:
\“postback\”, \“title\”: \“<button title>\”, \“value\”:
\“<postback text>\”}, {\“type\”: \“phone-number\”, \“title\”:
\“<button title>\”, \“value\”: \“<phone number>\”}]},
\“delay\”: 0}
- If multiple results are received use this list type:
{\“type\”: \“list\”, \“content\”: {\“title”: \“Your search
results\”, \“imageUrl\”: \“company-icon://activate\”,
\“subtitle\”: \“Here's the full list of what I found for
you.\, \“elements\”: [ {{#eachJoin response}} {\“title\”:
\“{{this.firstName}}\”, \“description\”:
\“{{this.username}}\”, \“buttons\”: [{\“title\”: \“Open
Topic\”, \“value\”: \“www.company.com\”, \“type\”:
\“web_url\”}]} {{/eachJoin} }}}
- Only add buttons if there is some relevant data in the
input context.
- Only use a postback button when you want to trigger an
action or send data back to the assistant.
- Use #eachJoin to iterate over an array in the response”
},
{
“role”: “user”,
“content”: “You have the following API request response:
<? response ?>”
}

Example prompt data for metalanguage generation is included below merely to illustrate certain aspects of the disclosure. It will be appreciated that certain context data (e.g., a backend response) is not shown below.

```
  “role”: “system”,
  “content”: “You are a response generation system whose
task is to generate a predefined metalanguage. Your responses
must follow a specific format, and you should only use the
provided context data to generate your response.
Instructions:
- Only add buttons if there is some relevant data in your
context - Respond with a complete structure
- If you receive just one result entry use this card format:
{ \“type\”: \“card\”, \“content\”: { \“title\”: \“<title>\”,
\“subtitle\”: \“<subtitle>\”, \“imageUrl\”: \“<image url>\”,
\“buttons\”: [ { \“type\”: \“link\”, \“title\”: \“<button
title>\”, \“value\”: \“<link_url>\” }, { \“type\”:
\“postback\”, \“title\”: \“<button title>\”, \“value\”:
\“<postback text>\” }, { \“type\”: \“phone-number\”,
\“title”: \“<button title>\”, \“value\”: \“<phone number>\”
} ] }, \“delay\”: 0 }
- If multiple results are received use this list metalanguage
- The metalanguage uses curly braces to denote different
sections of the data structure. The top-level section is
called List, which contains a title (ti), a subtitle (st), an
icon URL (iurl), and a list of items. Each item in the list
represents a user and contains information such as their name
(it), their profile (is), a description (d), and a list of
buttons associated with that user. Each button in the list of
buttons has a type (bty), a name (bt), and a value (bv). The
type specifies the type of button (e.g. link, postback,
phone-number), the name is the text displayed on the button,
and the value is the URL or other data associated with the
button.
- Do not use any quotes or commas
- The \“+\” symbol indicates the end of a button object or
the end of an item if no buttons are available.
- If you do not find any matching format: {\“type\”:
\“text\”, \“content\”: \“<here your answer for no
response>\”}”
},
{
  “role”: “user”,
  “content”:
“{\“d\”:{\“results\”:[{\“firstName\”:\“Max\”,\“displayName\”:
\“Max
Johnson\”,\“_{——}metadata\”:{\“type\”:\“SData.User\”,\“uri\”:\“h
ttps://apisales.company.com/odata/v2/User(121212)\”},\“userId
\”:\“121212\”,\“username\”:\“mjohnson},
{\“firstName\”:\“Max\”,\“displayName\”:\“Max
Smith”,\“_{——}metadata\”:{\“type\”:\“SData.User\”,\“uri\”:\“htt
ps://apisales.company.com/odata/v2/User(100101)\”},\“userId\”
:\“100101\”,\“username\”:\“msmith\”}]}}”
},
{
  “role”: “assistant”,
  “content”: “{ List: { ti: Users st: Here you can see all
users iurl: https://company-icons-
png.flaticon.com/512/107.png items: [ { it: Max Johnson is:
mjohnson d: user Id: 121212 buttons: [ { bty: link bt: Go to
profile bv:
https://apisales.company.com/odata/v2/User(‘121212’) +} ] },
{ it: Max Smith is: msmith d: user Id: 100101 buttons: [ {
bty: link bt: Go to profile bv:
https://apisales.company.com/odata/v2/User(‘100101’) +} ] } ]
} }”
},
{
  “role”: “user”,
  “content”: “You have the following API request response:
<? response ?>”
}
```

It is noted that the above metalanguage-related example uses metalanguage for displaying a list, as a list could contain multiple items. It is further noted that, in the above examples of scripting and metalanguage, the identified “roles” are specific to an example API that can be employed. Prompt formats or styles may be varied and do not necessarily include such explicit role identifiers. In the above examples, the content associated with the “system” role refers to general personality and instructions provided to an LLM, the content associated with the “user” role may include actual user utterances or input messages, while the content associated with the “assistant” role can include messages generated by a digital assistant. In the above examples, the “user” role does not refer to an end user and instead provides backend response content as input to the LLM, since the LLM call is essentially a secondary step for response generation after a function has been automatically selected and executed prior to the LLM call (e.g., via one or more other LLM calls that occurred earlier in time).

The intermediate representation 506 is generated by the generative machine learning model based on the generative machine learning model input 504 (e.g., the prompt data). As mentioned, this representation may act as a bridge between the raw output from a backend component or service and a final structured message format. In some examples, the intermediate representation 506 is more abstract than the final output, containing a structural blueprint for the message (e.g., by utilizing placeholders or condensed language that will later be expanded into a full message).

When instructing the generative machine learning model to generate the intermediate representation 506 using scripting syntax, the generative machine learning model may generate a scaffold where placeholders are defined, and the scripting syntax specifies how data from the backend response should be inserted into these placeholders. This may allow the digital assistant service system 126 to resolve the scripting syntax at runtime, providing a flexible and efficient way to generate customized responses without the need to generate a new template for each unique response. In some examples, the intermediate representation 506 can be generated as a scripting syntax representation during design time and utilized multiple times at runtime to execute the same or similar tasks, thereby reducing the number of prompts sent to and processed by the generative machine learning model at runtime.

An example of a scripting syntax representation is included below. It will be appreciated that the scripting syntax representation shown below is not intended to be complete or exhaustive, but rather illustrative of certain aspects.

```
“elements”:
[
  {{#eachJoin response}}
    {
      “title”: “{{this.firstName}}”,
      “description”: “{{this.username}}”,
      “buttons”:
      [
        {
          “title”: “Users”,
          “value”: “{{this.url}}”,
          “type”: “link”
        }
      ]
  {{/eachJoin}}
]
```

The above example leverages a scripting language with Handlebars syntax to dynamically generate the intermediate representation based on the backend response. It is noted that the scripting language supports iterative operations, and thus allows for looping over the response data when generating the output data structure from the intermediate representation. For example, the intermediate representation may include the same number of tokens irrespective of the number of entries of a particular field or category returned in a particular backend response. An approach that allows for iterative or conditional operations may be highly useful when a backend response is relatively large or complex and would otherwise require a large number of tokens to be generated by a generative machine learning model (e.g., to perform direct template filling).

When instructing the generative machine learning model to generate the intermediate representation 506 by producing metalanguage, the generative machine learning model may produce an intermediate, simplified language that abstracts or condenses certain details. An example extract of a condensed metalanguage representation is included below. It will be appreciated that the condensed metalanguage representation shown below is not intended to be complete or exhaustive, but rather illustrative of certain aspects.

```
{
  List: {
    ti: Users
    st: Here you can see all users
    iurl: https://icons-png.flaticon.com/512/107.png
    items: [
      {
        it: Anne
        is: A student
        d: Anne is a dedicated student studying biology
        buttons: [
          {
            bty: link
            bt: name
            bv: https://icons-png.flaticon.com/512/107.png
          +
          },
          {
            bty: postback
            bt: name
            bv: https://icons-png.flaticon.com/512/107.png
            +
},
```

In the above example, the intermediate representation 506 uses a custom shorthand notation that omits quotation marks and employs abbreviations (e.g., “ti” for “title,” and “st” for “subtitle”) to reduce the size and complexity of the output to be generated by the generative machine learning model. This metalanguage is designed to be processed by a compiler or a similar tool that translates it into the final output data structure.

In this way, at least in some examples, the number of tokens to be generated by the generative machine learning model can be reduced when compared to a direct template filling approach, and generative machine learning model outputs can be more rapidly obtained. For example, a single quotation mark can be regarded as a full token, meaning that multiple quotation marks in text is not insignificant from a cost or time perspective. By avoiding the use of quotation marks in the intermediate representation 506 and only adding the quotation marks later (outside of the generative machine learning model context), greater token efficiency can be achieved by the digital assistant service system 126.

In some examples, the digital assistant service system 126 supports both scripting and metalanguage approaches. For example, the digital assistant service system 126 may select one of the approaches automatically based on the type of backend response it is dealing with.

Still referring to the process 500 of FIG. 5, the digital assistant service system 126 then processes the intermediate representation 506 to resolve or compile it into a message in structured format 508, which is a fully realized data structure ready for use to render suitable user interface elements 510 in the user interface of the digital assistant (e.g., in the web interface 132 or the app interface 134 of FIG. 1).

Where the intermediate representation 506 contains scripting code, the digital assistant service system 126 may execute a resolver module that uses the response data from the backend response 502 to process the intermediate representation 506 and output the message in structured format 508. The resolver module may be configured to assign fields from the backend response 502 to corresponding fields generated by the generative machine learning model. The resolver module may also be configured to execute conditional, iterative, or other operations as defined in the scripting code.

Where the intermediate representation 506 contains metalanguage, the digital assistant service system 126 may execute a metalanguage compiler module that understands the vocabulary utilized in the intermediate representation 506 and can thus transform the intermediate representation 506 into the message in structured format 508. The compiler module reduces the computational load on the generative machine learning model.

In some examples, the message in structured format 508 is in JSON format and contains the data needed to render one or more user interface elements, such as text, buttons, and other interactive components, at the user device 106. The message in structured format 508 is thus in a form that is ready to be translated into user interface elements, whereas the intermediate representation 506 is an intermediate or transitional representation. An example extract from such a message in structured format 508 is included below:

```
“elements”: [
  {
    “title”: “Anne”,
    “subtitle”: “anne1234”,
    “buttons”: [
      [
        “title”: “Open Topic”,
        “type”: “web_url”,
        “value”: “www.company.com”
      }
    ],
  },
  }
    “title”: “Jana”,
    “subtitle”: “jana2345”,
    “description”: “A student”
  }
]
```

The digital assistant service system 126 then uses the message in structured format 508 to create user interface elements 510 in the user interface associated with the digital assistant. For example, the digital assistant service system 126 causes presentation of visual components, such as text that provides information and buttons that the user interacts with.

The message in structured format 508 therefore provides the digital assistant service system 126 or an application at the user device 106 with definitions or attributes for various user interface elements. A rendering engine can then interpret each element and construct the corresponding user interface components based on the data provided. A rendering process may involve creating, by a computing system, HTML (HyperText Markup Language) elements for web-based presentation (e.g., via the web client 112 of FIG. 1) or native user interface components for mobile application presentation (e.g., via the programmatic client 110 of FIG. 1). For example, the web client 112 providing the web interface 132 receives the message in structured format 508, and renders the relevant user interface elements in the web interface 132 as part of a digital assistant window or tab.

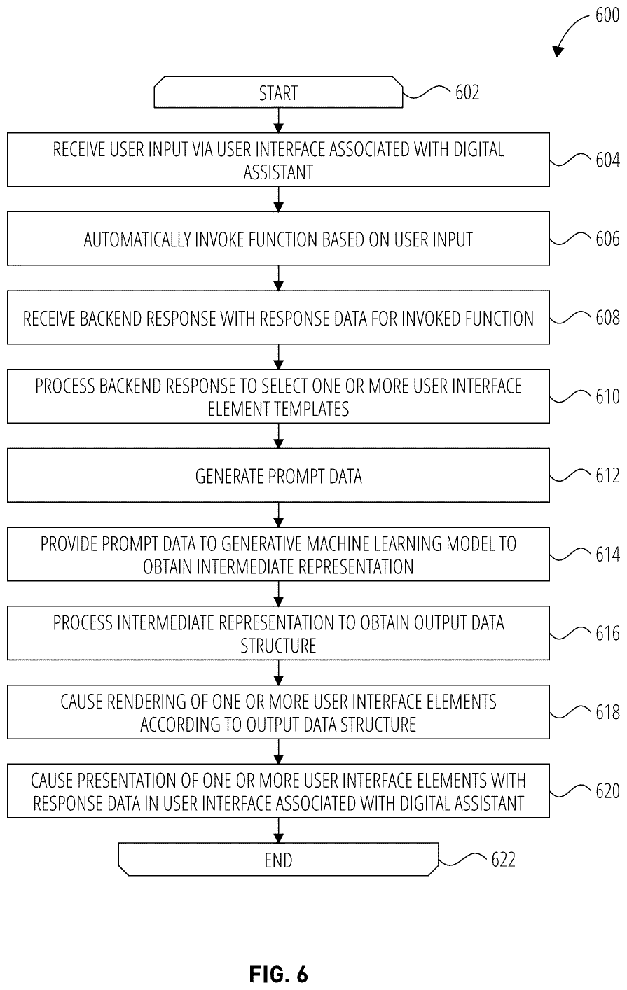

FIG. 6 is a flowchart illustrating operations of a method 600 suitable for using a generative machine learning model to facilitate rendering of user interface elements in a user interface associated with digital assistant, according to some examples. By way of example and not limitation, aspects of the method 600 may be performed by components, devices, systems, networks, or databases shown in FIG. 1 to FIG. 4. Accordingly, elements shown in one or more of FIG. 1 to FIG. 4 are referenced in the description below as non-limiting examples.

The method 600 commences at opening loop operation 602 and proceeds to operation 604, where the digital assistant service system 126 receives user input via a user interface associated with a digital assistant. For example, the user 108 accesses the digital assistant via the web client 112 of FIG. 1 and submits a message or query. For example, the user 108 can ask a simple question, such as “What's the weather like today?”, or submit a more complex query, such as “Help me to generate a new job position in the organization.”

At operation 606, the digital assistant service system 126 automatically invokes a function supported by the digital assistant based on the user input. In some cases, a generative machine learning model (e.g., the LLM 118, which is used as an example below) is prompted to facilitate automated function calling. The digital assistant service system 126 may select a set of functions from a plurality of functions supported by the digital assistant to share with the LLM 118 as part of its prompt data.

Various techniques may be used to select functions. The functions can be selected, for example, based on the user input submitted by the user, based on a user profile of the user, based on previous interactions, based on dependencies between functions, or combinations thereof. In some examples, retrieval-augmented generation (RAG) techniques are implemented by the digital assistant service system 126 (e.g., by the bot component 204 of FIG. 2). RAG is a technique that combines the capabilities of a retrieval system with a generative machine learning model. In the context of digital assistants, RAG can be employed to preselect relevant functions by retrieving a subset of information from a large database or knowledge base that is pertinent to the user's query or context (e.g., functions that relate to a conversation topic or are semantically similar to a query based on vector similarity). The retrieval acts as a filtering mechanism, narrowing down the potential functions that the generative machine learning model should consider. For instance, if a user asks about retrieving a list of employees, the digital assistant service system 126 might retrieve, from the database 130 of FIG. 1, functions related to data aggregation, human resources, and report generation, while omitting unrelated functions such as financial, scheduling, or email management functions. The RAG approach may ensure that the generative machine learning model, including its context window, is not overwhelmed by the full scope of available functions, which can lead to inefficiencies, irrelevant suggestions, higher computing costs, or insufficient context availability.

After the LLM 118 has processed relevant prompt data that includes the user input, the digital assistant service system 126 receives a response from the LLM 118 that the digital assistant service system 126 identifies as a function call. For example, the response includes a function identifier and parameter values for its parameters. It is noted that, in some cases, various messages may be exchanged between the digital assistant and the user 108 to obtain the relevant parameter values from the user 108. The LLM 118 can also be utilized to generate such messages (e.g., direct responses).

The digital assistant service system 126 then causes the function to be invoked (e.g., using the function invoking component 208 of FIG. 2). At operation 608, the digital assistant service system 126 receives a backend response. The backend response includes response data for the invoked function. For example, the backend response can be a JSON object received from the backend service 314 and that includes the identities of employees requested by the user 108 in their query.

The digital assistant service system 126 processes the backend response (e.g., using the bot component 204) to select one or more user interface element templates at operation 610. Processing of the backend response and inferring or selecting a suitable template can ensure that the appropriate response is generated that includes relevant user interface elements, such as relevant natural language (e.g., text objects), relevant formats or structures (e.g., lists or tables), and relevant interactive elements (e.g., buttons).

The method 600 proceeds to operation 612, where the digital assistant service system 126 generates prompt data. As mentioned, in some cases, the LLM 118 might be utilized to perform direct template filling. In such cases, the LLM 118 is prompted to utilize the selected user interface element template and directly generate the output data structure (e.g., JSON format message for downstream rendering). However, direct template filling can lead to relatively large numbers of tokens being generated and can cause performance issues, particularly when dealing with large, complex responses. Accordingly, in the method 600 of FIG. 6, to improve performance or reduce the number of tokens to be generated by the LLM 118, the prompt data instructs the LLM 118 to generate an intermediate representation (operation 614).

The LLM 118 can generate the intermediate representation based on an instruction and sufficient contextual information, such as details of the relevant user interface element templates, response data, or conversation history. At operation 616, the digital assistant service system 126 processes the intermediate representation to obtain the output data structure for the backend response of operation 608.

In some examples, the intermediate representation comprises a scripting syntax representation, and the processing of the intermediate representation comprises using, by the digital assistant service system 126, the response data to automatically resolve scripting code of the scripting syntax representation to obtain the output data structure. As mentioned, the scripting syntax representation may include one or more placeholders for at least a subset of the response data. Furthermore, the scripting syntax representation can be generated by the LLM 118 using a scripting language that supports iterative operations with respect to the response data in the resolving of the scripting code or conditional operations with respect to the response data in the resolving of the scripting code.

In some examples, the intermediate representation comprises a condensed metalanguage representation, and the processing of the intermediate representation comprises compiling, by the digital assistant service system 126, metalanguage of the condensed metalanguage representation to obtain the output data structure. The prompt data may include at least a subset of a predetermined vocabulary for generating the condensed metalanguage representation, and the predetermined vocabulary may then be used by the digital assistant service system 126 to automatically compile the metalanguage of the condensed metalanguage representation. Such a vocabulary can include abbreviations for user interface elements or abbreviations for components of interface elements (as illustrated in the above example).

In the method 600, the intermediate representation has a first data format (e.g., a scripting code format or a metalanguage format) while the output data structure has a second data format (e.g., JSON) that differs from the first data format. In at least some cases, the intermediate representation comprises fewer tokens than the output data structure.

The method 600 proceeds to operation 618, where the digital assistant service system 126 causes the rendering of one or more user interface elements based on the generated output data structure. For example, the bot component 204 submits the final JSON message (as generated from the intermediate representation) to the web client 112 via the channel connector component 202, and the message is parsed at the user device 106 to determine which user interface elements to render. The one or more user interface elements are then presented at the user device 106 in the user interface associated with the digital assistant at operation 620. The user device 106 can review the information provided via a user interface element, or can interact with an interactive user interface element. The method 600 concludes at closing loop operation 622.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.
Example 1 is a system comprising: at least one memory that stores instructions; and one or more processors configured by the instructions to perform operations comprising: accessing a backend response comprising response data, the backend response having been generated automatically in response to user input provided via a user interface associated with a digital assistant; generating prompt data comprising an instruction to generate an intermediate representation of an output data structure supported by the digital assistant; providing the prompt data to a generative machine learning model to obtain the intermediate representation; processing the intermediate representation to obtain the output data structure; and causing, based on the output data structure, rendering of one or more user interface elements to present the response data via the user interface associated with the digital assistant.
In Example 2, the subject matter of Example 1 includes, wherein the intermediate representation is a scripting syntax representation or a condensed metalanguage representation.
In Example 3, the subject matter of any of Examples 1-2 includes, wherein the output data structure comprises a message in a predetermined format supported by the digital assistant, and the message is processed to generate the one or more user interface elements to present the response data via the user interface.
In Example 4, the subject matter of any of Examples 1-3 includes, wherein the intermediate representation comprises a scripting syntax representation, and the processing of the intermediate representation comprises using the response data to resolve scripting code of the scripting syntax representation to obtain the output data structure.
In Example 5, the subject matter of Example 4 includes, wherein the scripting syntax representation comprises one or more placeholders for at least a subset of the response data.
In Example 6, the subject matter of any of Examples 4-5 includes, wherein the scripting syntax representation is generated using a scripting language that supports at least one of: iterative operations with respect to the response data in the resolving of the scripting code, or conditional operations with respect to the response data in the resolving of the scripting code.
In Example 7, the subject matter of any of Examples 1-6 includes, wherein the intermediate representation comprises a condensed metalanguage representation, and the processing of the intermediate representation comprises compiling metalanguage of the condensed metalanguage representation to obtain the output data structure.
In Example 8, the subject matter of Example 7 includes, wherein the prompt data comprises at least a subset of a predetermined vocabulary for generating the condensed metalanguage representation, and the predetermined vocabulary is used to compile the metalanguage of the condensed metalanguage representation.
In Example 9, the subject matter of Example 8 includes, wherein the predetermined vocabulary comprises at least one of: abbreviations for the one or more user interface elements, or abbreviations for components of the one or more interface elements.
In Example 10, the subject matter of any of Examples 1-9 includes, the operations further comprising: selecting, based on the backend response, one or more user interface element templates, wherein the one or more user interface element templates are identified in the prompt data provided to the generative machine learning model, and the one or more user interface elements rendered via the user interface each correspond to one of the one or more user interface element templates.
In Example 11, the subject matter of any of Examples 1-10 includes, wherein the intermediate representation has a first data format and the output data structure has a second data format that differs from the first data format, and the intermediate representation comprises fewer tokens than the output data structure.
In Example 12, the subject matter of any of Examples 1-11 includes, wherein the one or more user interface elements comprise at least one of: a button object, a list object, a card object, a text object, a hyperlink object, a table object, or a chart object.
In Example 13, the subject matter of any of Examples 1-12 includes, the operations further comprising: identifying, based at least partially on the user input, a function identifier associated with a function from among a plurality of functions supported by the digital assistant; and automatically invoking the function to obtain the backend response.
In Example 14, the subject matter of any of Examples 1-13 includes, wherein the generative machine learning model comprises a large language model (LLM).
Example 15 is a method comprising: accessing, by one or more processors, a backend response comprising response data, the backend response having been generated automatically in response to user input provided via a user interface associated with a digital assistant; generating, by the one or more processors, prompt data comprising an instruction to generate an intermediate representation of an output data structure supported by the digital assistant; providing, by the one or more processors, the prompt data to a generative machine learning model to obtain the intermediate representation; processing, by the one or more processors, the intermediate representation to obtain the output data structure; and causing, by the one or more processors and based on the output data structure, rendering of one or more user interface elements to present the response data via the user interface associated with the digital assistant.
In Example 16, the subject matter of Example 15 includes, wherein the intermediate representation is a scripting syntax representation or a condensed metalanguage representation.
In Example 17, the subject matter of any of Examples 15-16 includes, wherein the intermediate representation has a first data format and the output data structure has a second data format that differs from the first data format, and the intermediate representation comprises fewer tokens than the output data structure.
Example 18 is a non-transitory computer-readable medium that stores instructions that, when executed by one or more processors, cause the one or more processors to perform operations comprising: accessing a backend response comprising response data, the backend response having been generated automatically in response to user input provided via a user interface associated with a digital assistant; generating prompt data comprising an instruction to generate an intermediate representation of an output data structure supported by the digital assistant; providing the prompt data to a generative machine learning model to obtain the intermediate representation; processing the intermediate representation to obtain the output data structure; and causing, based on the output data structure, rendering of one or more user interface elements to present the response data via the user interface associated with the digital assistant.
In Example 19, the subject matter of Example 18 includes, wherein the intermediate representation is a scripting syntax representation or a condensed metalanguage representation.
In Example 20, the subject matter of any of Examples 18-19 includes, wherein the intermediate representation has a first data format and the output data structure has a second data format that differs from the first data format, and the intermediate representation comprises fewer tokens than the output data structure.
Example 21 is at least one machine-readable medium including instructions that, when executed by processing circuitry, cause the processing circuitry to perform operations to implement any of Examples 1-20.
Example 22 is an apparatus comprising means to implement any of Examples 1-20.
Example 23 is a system to implement any of Examples 1-20.
Example 24 is a method to implement any of Examples 1-20.

FIG. 7 is a block diagram showing a machine learning program 700, according to some examples. Machine learning programs, also referred to as machine learning algorithms or tools, may be used as part of the systems described herein to perform one or more operations.

Machine learning is a field of study that gives computers the ability to learn without being explicitly programmed. Machine learning explores the study and construction of algorithms, also referred to herein as tools, that may learn from or be trained using existing data and make predictions about or based on new data. Such machine learning tools operate by building a model from example training data 708 in order to make data-driven predictions or decisions expressed as outputs or assessments (e.g., assessment 716). Although examples are presented with respect to a few machine learning tools, the principles presented herein may be applied to other machine learning tools.

In some examples, different machine learning tools may be used. For example, Logistic Regression (LR), Naive-Bayes, Random Forest (RF), neural networks (NN), matrix factorization, and Support Vector Machines (SVM) tools may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine learning program 700 supports two types of phases, namely training phases 702 and prediction phases 704. In training phases 702, supervised learning, unsupervised or reinforcement learning may be used. For example, the machine learning program 700 (1) receives features 706 (e.g., as structured or labeled data in supervised learning) and/or (2) identifies features 706 (e.g., unstructured or unlabeled data for unsupervised learning) in training data 708. In prediction phases 704, the machine learning program 700 uses the features 706 for analyzing query data 712 to generate outcomes or predictions, as examples of an assessment 716.

In the training phase 702, feature engineering is used to identify features 706 and may include identifying informative, discriminating, and independent features for the effective operation of the machine learning program 700 in pattern recognition, classification, and regression. In some examples, the training data 708 includes labeled data, which is known data for pre-identified features 706 and one or more outcomes. Each of the features 706 may be a variable or attribute, such as individual measurable property of a process, article, system, or phenomenon represented by a data set (e.g., the training data 708). Features 706 may also be of different types, such as numeric features, strings, and graphs, and may include one or more of content 718, concepts 720, attributes 722, historical data 724 and/or user data 726, merely for example.

The concept of a feature in this context is related to that of an explanatory variable used in statistical techniques such as linear regression. Choosing informative, discriminating, and independent features is important for the effective operation of the machine learning program 700 in pattern recognition, classification, and regression. Features may be of different types, such as numeric features, strings, and graphs.

In training phases 702, the machine learning program 700 uses the training data 708 to find correlations among the features 706 that affect a predicted outcome or assessment 716. With the training data 708 and the identified features 706, the machine learning program 700 is trained during the training phase 702 at machine learning program training 710. The machine learning program 700 appraises values of the features 706 as they correlate to the training data 708. The result of the training is the trained machine learning program 714 (e.g., a trained or learned model).

Further, the training phases 702 may involve machine learning, in which the training data 708 is structured (e.g., labeled during preprocessing operations), and the trained machine learning program 714 implements a relatively simple neural network 728 capable of performing, for example, classification and clustering operations. In other examples, the training phase 702 may involve deep learning, in which the training data 708 is unstructured, and the trained machine learning program 714 implements a deep neural network 728 that is able to perform both feature extraction and classification/clustering operations.

A neural network 728 generated during the training phase 702, and implemented within the trained machine learning program 714, may include a hierarchical (e.g., layered) organization of neurons. For example, neurons (or nodes) may be arranged hierarchically into a number of layers, including an input layer, an output layer, and multiple hidden layers. Each of the layers within the neural network 728 can have one or many neurons and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network 728 may also be one of a number of different types of neural networks, including a single-layer feed-forward network, an Artificial Neural Network (ANN), a Recurrent Neural Network (RNN), a symmetrically connected neural network, and unsupervised pre-trained network, a transformer network, a Convolutional Neural Network (CNN), or a Recursive Neural Network (RNN), merely for example.

During prediction phases 704, the trained machine learning program 714 is used to perform an assessment. Query data 712 is provided as an input to the trained machine learning program 714, and the trained machine learning program 714 generates the assessment 716 as output, responsive to receipt of the query data 712.

In some examples, the trained machine learning program 714 may be a generative AI model. Generative AI is a term that may refer to AI that can create new content. For example, generative AI can produce text, images, video, audio, code, or synthetic data. In some examples, the generated content may be similar to the original data, but not identical.

Some of the techniques that may be used in generative AI are:
CNNs: CNNs may be used for image recognition and computer vision tasks. CNNs may, for example, be designed to extract features from images by using filters or kernels that scan the input image and highlight important patterns.
RNNs: RNNs may be used for processing sequential data, such as speech, text, and time series data, for example. RNNs employ feedback loops that allow them to capture temporal dependencies and remember past inputs.
GANs: GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code. For example, the LLM 118 of FIG. 1 or another LLM referred to herein may be a transformer model, or may be based on a transformer model. Non-limiting examples of LLMs that use transformer models include GPT-4 (Generative Pre-trained Transformer 4) developed by OpenAI™, BERT (Bidirectional Encoder Representations from Transformers) developed by Google™ LLAMA (Large Language Model Meta AI) developed by Meta™, PaLM2 (Pathways Language Model 2) developed by Google™, and Claude 3 developed by Anthropic™.

In generative AI examples, the assessment 716 generated as a response or output by the trained machine learning program 714 may include predictions, translations, summaries, answers to questions, suggestions, media content, or combinations thereof. For example, the LLM 118 of FIG. 1 may generate natural language responses in a conversational style, or the LLM 118 may generate function calls that align with a specific schema. In some examples, the LLM 118 can generate intermediate representations as described elsewhere herein.

In some examples, a machine learning model may be fine-tuned. The term “fine-tuning,” as used herein, generally refers to a process of adapting a pre-trained machine learning model. For example, a machine learning model may be adapted to improve its performance on a specific task or to make it more suitable for a specific operation. Fine-tuning techniques may include one or more of updating or changing a pre-trained model's internal parameters through additional training, injecting new trainable weights or layers into the model architecture and training on those weights or layers, modifying a model topology by altering layers or connections, changing aspects of the training process (such as loss functions or optimization methods), or any other adaptations that may, for example, result in better model performance on a particular task compared to the pre-trained model. In some examples, the LLM 118 is fine-tuned from a pre-trained model to improve its performance in one or more tasks described herein.

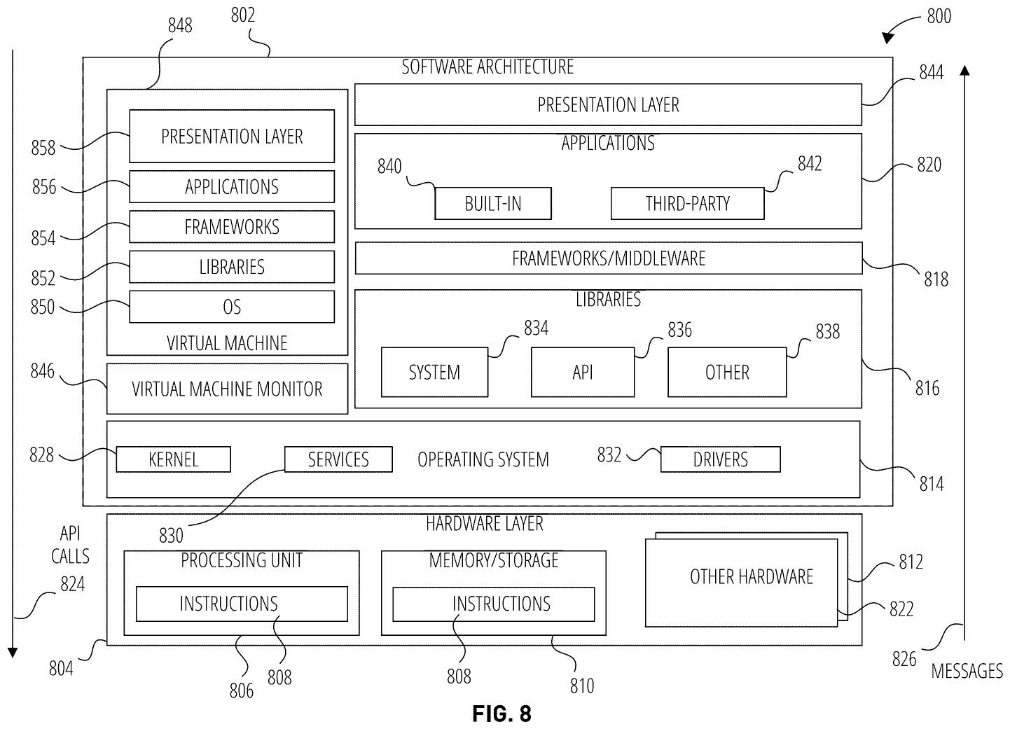

FIG. 8 is a block diagram 800 showing a software architecture 802 for a computing device, according to some examples. The software architecture 802 may be used in conjunction with various hardware architectures, for example, as described herein. FIG. 8 is merely a non-limiting illustration of a software architecture, and many other architectures may be implemented to facilitate the functionality described herein. A representative hardware layer 804 is illustrated and can represent, for example, any of the above referenced computing devices. In some examples, the hardware layer 804 may be implemented according to the architecture of the computer system of FIG. 9.

The representative hardware layer 804 comprises one or more processing units 806 having associated executable instructions 808. Executable instructions 808 represent the executable instructions of the software architecture 802, including implementation of the methods, modules, subsystems, and components, and so forth described herein and may also include memory and/or storage modules 810, which also have executable instructions 808. Hardware layer 804 may also comprise other hardware as indicated by other hardware 812 and other hardware 822 which represent any other hardware of the hardware layer 804, such as the other hardware illustrated as part of the software architecture 802.

In the architecture of FIG. 8, the software architecture 802 may be conceptualized as a stack of layers where each layer provides particular functionality. For example, the software architecture 802 may include layers such as an operating system 814, libraries 816, frameworks/middleware layer 818, applications 820, and presentation layer 844. Operationally, the applications 820 or other components within the layers may invoke API calls 824 through the software stack and access a response, returned values, and so forth illustrated as messages 826 in response to the API calls 824. The layers illustrated are representative in nature and not all software architectures have all layers. For example, some mobile or special purpose operating systems may not provide a frameworks/middleware layer 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of an interrupt and, in response, cause the software architecture 802 to pause its current processing and execute an interrupt service routine (ISR) when an interrupt is accessed.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 816 may provide a common infrastructure that may be utilized by the applications 820 or other components or layers. The libraries 816 typically provide functionality that allows other software modules to perform tasks in an easier fashion than to interface directly with the underlying operating system 814 functionality (e.g., kernel 828, services 830 or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks/middleware layer 818 may provide a higher-level common infrastructure that may be utilized by the applications 820 or other software components/modules. For example, the frameworks/middleware layer 818 may provide various graphic user interface (GUI) functions, high-level resource management, high-level location services, and so forth. The frameworks/middleware layer 818 may provide a broad spectrum of other APIs that may be utilized by the applications 820 or other software components/modules, some of which may be specific to a particular operating system or platform.

The applications 820 include built-in applications 840 or third-party applications 842. Examples of representative built-in applications 840 may include, but are not limited to, a contacts application, a browser application, a book reader application, a location application, a media application, a messaging application, or a game application. Third-party applications 842 may include any of the built-in applications as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 842 may invoke the API calls 824 provided by the mobile operating system such as operating system 814 to facilitate functionality described herein.

The applications 820 may utilize built in operating system functions (e.g., kernel 828, services 830 or drivers 832), libraries (e.g., system libraries 834, API libraries 836, and other libraries 838), and frameworks/middleware layer 818 to create user interfaces to interact with users of the system. Alternatively, or additionally, in some systems, interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware computing device. A virtual machine is hosted by a host operating system (operating system 814) and typically, although not always, has a virtual machine monitor 846, which manages the operation of the virtual machine as well as the interface with the host operating system (e.g., operating system 814). A software architecture executes within the virtual machine 848 such as an operating system 850, libraries 852, frameworks/middleware 854, applications 856 or presentation layer 858. These layers of software architecture executing within the virtual machine 848 can be the same as corresponding layers previously described or may be different.

Certain examples are described herein as including logic or a number of components, modules, or mechanisms. Modules or components may constitute either software modules/components (e.g., code embodied (1) on a non-transitory machine-readable medium or (2) in a transmission signal) or hardware-implemented modules/components. A hardware-implemented module/component is a tangible unit capable of performing certain operations and may be configured or arranged in a certain manner. In examples, one or more computer systems (e.g., a standalone, client, or server computer system) or one or more hardware processors may be configured by software (e.g., an application or application portion) as a hardware-implemented module/component that operates to perform certain operations as described herein.

In various examples, a hardware-implemented module/component may be implemented mechanically or electronically. For example, a hardware-implemented module/component may comprise dedicated circuitry or logic that is permanently configured (e.g., as a special-purpose processor, such as a field programmable gate array (FPGA) or an application-specific integrated circuit (ASIC)) to perform certain operations. A hardware-implemented module/component may also comprise programmable logic or circuitry (e.g., as encompassed within a general-purpose processor or another programmable processor) that is temporarily configured by software to perform certain operations.

Accordingly, the term “hardware-implemented module” or “hardware-implemented component” should be understood to encompass a tangible entity, be that an entity that is physically constructed, permanently configured (e.g., hardwired), or temporarily or transitorily configured (e.g., programmed) to operate in a certain manner or to perform certain operations described herein. Considering examples in which hardware-implemented modules/components are temporarily configured (e.g., programmed), each of the hardware-implemented modules/components need not be configured or instantiated at any one instance in time. For example, where the hardware-implemented modules/components comprise, a general-purpose processor configured using software, the general-purpose processor may be configured as respective different hardware-implemented modules/components at different times. Software may accordingly configure a processor, for example, to constitute a particular hardware-implemented module/component at one instance of time and to constitute a different hardware-implemented module/component at a different instance of time.

Hardware-implemented modules/components can provide information to, and receive information from, other hardware-implemented modules/components. Accordingly, the described hardware-implemented modules/components may be regarded as being communicatively coupled. Where multiple of such hardware-implemented modules/components exist contemporaneously, communications may be achieved through signal transmission (e.g., over appropriate circuits and buses that connect the hardware-implemented modules/components). In examples in which multiple hardware-implemented modules/components are configured or instantiated at different times, communications between such hardware-implemented modules/components may be achieved, for example, through the storage and retrieval of information in memory structures to which the multiple hardware-implemented modules/components have access. For example, one hardware-implemented module/component may perform an operation, and store the output of that operation in a memory device to which it is communicatively coupled. A further hardware-implemented module/component may then, at a later time, access the memory device to retrieve and process the stored output.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules/components that operate to perform one or more operations or functions. The modules/components referred to herein may, in some examples, comprise processor-implemented modules/components.

Similarly, the methods described herein may be at least partially processor-implemented. For example, at least some of the operations of a method may be performed by one or more processors or processor-implemented modules/components. The performance of certain of the operations may be distributed among the one or more processors, not only residing within a single machine, but deployed across a number of machines.

The one or more processors may also operate to support performance of the relevant operations in a “cloud computing” environment or as a “software as a service (SaaS).” For example, at least some of the operations may be performed by a group of computers (as examples of machines including processors), these operations being accessible via a network (e.g., the Internet) and via one or more appropriate interfaces (e.g., APIs).

Examples may be implemented in digital electronic circuitry, or in computer hardware, firmware, or software, or in combinations of them. Examples may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

FIG. 9 is a block diagram of a machine in the example form of a computer system 900 within which instructions 924 may be executed for causing the machine to perform any one or more of the methodologies discussed herein. In alternative examples, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a GPU, or both), a primary or main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a UI navigation (or cursor control) device 914 (e.g., a mouse), a storage unit 916, a signal generation device 918 (e.g., a speaker), and a network interface device 920.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a CPU, a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware.

The storage unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 or within the processor 902 during execution thereof by the computer system 900, with the main memory 904 and the processor 902 also each constituting a machine-readable medium 922.

While the machine-readable medium 922 is shown in accordance with some examples to be a single medium, the term “machine-readable medium” may include a single medium or multiple media (e.g., a centralized or distributed database, or associated caches and servers) that store the one or more instructions 924 or data structures. The term “machine-readable medium” shall also be taken to include any tangible medium that is capable of storing, encoding, or carrying instructions 924 for execution by the machine and that cause the machine to perform any one or more of the methodologies of the present disclosure, or that is capable of storing, encoding, or carrying data structures utilized by or associated with such instructions 924. The term “machine-readable medium” shall accordingly be taken to include, but not be limited to, solid-state memories, and optical and magnetic media. Specific examples of a machine-readable medium 922 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 924 may further be transmitted or received over a communications network 926 using a transmission medium. The instructions 924 may be transmitted using the network interface device 920 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 924 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the subject matter may be referred to herein, individually or collectively, by the term “example” merely for convenience and without intending to voluntarily limit the scope of this application to any single example or concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. Except as otherwise indicated, the word “or” in reference to a list of two or more items, covers all of the following interpretations of the word: any one of the items in the list, all of the items in the list, and any combination of the items in the list.

Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

What is claimed is:

1. A system comprising:
at least one memory that stores instructions; and
one or more processors configured by the instructions to perform operations comprising:
accessing a backend response comprising response data, the backend response having been generated automatically in response to user input provided via a user interface associated with a digital assistant;
generating prompt data comprising an instruction to generate an intermediate representation of an output data structure supported by the digital assistant;
providing the prompt data to a generative machine learning model to obtain the intermediate representation;
processing the intermediate representation to obtain the output data structure; and
causing, based on the output data structure, rendering of one or more user interface elements to present the response data via the user interface associated with the digital assistant.

2. The system of claim 1, wherein the intermediate representation is a scripting syntax representation or a condensed metalanguage representation.

3. The system of claim 1, wherein the output data structure comprises a message in a predetermined format supported by the digital assistant, and the message is processed to generate the one or more user interface elements to present the response data via the user interface.

4. The system of claim 1, wherein the intermediate representation comprises a scripting syntax representation, and the processing of the intermediate representation comprises using the response data to resolve scripting code of the scripting syntax representation to obtain the output data structure.

5. The system of claim 4, wherein the scripting syntax representation comprises one or more placeholders for at least a subset of the response data.

6. The system of claim 4, wherein the scripting syntax representation is generated using a scripting language that supports at least one of: iterative operations with respect to the response data in the resolving of the scripting code, or conditional operations with respect to the response data in the resolving of the scripting code.

7. The system of claim 1, wherein the intermediate representation comprises a condensed metalanguage representation, and the processing of the intermediate representation comprises compiling metalanguage of the condensed metalanguage representation to obtain the output data structure.

8. The system of claim 7, wherein the prompt data comprises at least a subset of a predetermined vocabulary for generating the condensed metalanguage representation, and the predetermined vocabulary is used to compile the metalanguage of the condensed metalanguage representation.

9. The system of claim 8, wherein the predetermined vocabulary comprises at least one of: abbreviations for the one or more user interface elements, or abbreviations for components of the one or more interface elements.

10. The system of claim 1, the operations further comprising:
selecting, based on the backend response, one or more user interface element templates, wherein the one or more user interface element templates are identified in the prompt data provided to the generative machine learning model, and the one or more user interface elements rendered via the user interface each correspond to one of the one or more user interface element templates.

11. The system of claim 1, wherein the intermediate representation has a first data format and the output data structure has a second data format that differs from the first data format, and the intermediate representation comprises fewer tokens than the output data structure.

12. The system of claim 1, wherein the one or more user interface elements comprise at least one of: a button object, a list object, a card object, a text object, a hyperlink object, a table object, or a chart object.

13. The system of claim 1, the operations further comprising:
identifying, based at least partially on the user input, a function identifier associated with a function from among a plurality of functions supported by the digital assistant; and
automatically invoking the function to obtain the backend response.

14. The system of claim 1, wherein the generative machine learning model comprises a large language model (LLM).

15. A method comprising:
accessing, by one or more processors, a backend response comprising response data, the backend response having been generated automatically in response to user input provided via a user interface associated with a digital assistant;
generating, by the one or more processors, prompt data comprising an instruction to generate an intermediate representation of an output data structure supported by the digital assistant;
providing, by the one or more processors, the prompt data to a generative machine learning model to obtain the intermediate representation;
processing, by the one or more processors, the intermediate representation to obtain the output data structure; and
causing, by the one or more processors and based on the output data structure, rendering of one or more user interface elements to present the response data via the user interface associated with the digital assistant.

16. The method of claim 15, wherein the intermediate representation is a scripting syntax representation or a condensed metalanguage representation.

17. The method of claim 15, wherein the intermediate representation has a first data format and the output data structure has a second data format that differs from the first data format, and the intermediate representation comprises fewer tokens than the output data structure.

18. A non-transitory computer-readable medium that stores instructions that, when executed by one or more processors, cause the one or more processors to perform operations comprising:
accessing a backend response comprising response data, the backend response having been generated automatically in response to user input provided via a user interface associated with a digital assistant;
generating prompt data comprising an instruction to generate an intermediate representation of an output data structure supported by the digital assistant;
providing the prompt data to a generative machine learning model to obtain the intermediate representation;
processing the intermediate representation to obtain the output data structure; and
causing, based on the output data structure, rendering of one or more user interface elements to present the response data via the user interface associated with the digital assistant.

19. The non-transitory computer-readable medium of claim 18, wherein the intermediate representation is a scripting syntax representation or a condensed metalanguage representation.

20. The non-transitory computer-readable medium of claim 18, wherein the intermediate representation has a first data format and the output data structure has a second data format that differs from the first data format, and the intermediate representation comprises fewer tokens than the output data structure.
